(19) United States
(12) Patent Application Publication
(10) Pub. No.: US 2016/0110461 A1
(43) Pub. Date: Apr. 21, 2016

(54) SYSTEM AND METHOD FOR PROVIDING DIGITAL MANUAL FOR VEHICLE

(71) Applicant: HYUNDAI MOTOR COMPANY, Seoul (KR)

(72) Inventors: Jaehyun Lee, Seoul (KR); Seung Chang Park, Seoul (KR)

(21) Appl. No.: 14/752,513

(22) Filed: Jun. 26, 2015

(30) Foreign Application Priority Data
Oct. 16, 2014 (KR) 10-2014-0140128

(51) Int. Cl. G06F 17/30

(52) U.S. Cl. CPC G06F 17/30867; G06F 17/30876; G06F 17/30654

(57) ABSTRACT

A system for providing a digital manual includes an information collector configured to collect model and option information of a first vehicle currently owned by a driver and model and option information of a second vehicle previously owned by the driver. A manual generator is configured to generate the digital manual based on the model and option information of the first vehicle and the model and option information of the second vehicle. A manual provider is configured to provide the digital manual to the first vehicle.

### CROSS-REFERENCE TO RELATED APPLICATION

This application claims the benefit of priority to Korean Patent Application No. 10-2014-0140128 filed in the Korean Intellectual Property Office on Oct. 16, 2014, the entire content of which is incorporated herein by reference.

### TECHNICAL FIELD

The present disclosure relates to a system and a method for providing a digital manual for a vehicle.

### BACKGROUND

A new vehicle has a manual having a booklet form to provide vehicle information of the vehicle. Since functions and operating methods thereof may be different for each vehicle, the manual provides the vehicle information to a driver so that the driver may efficiently use the functions of the vehicle.

When the manual is provided, it may be inconvenient and difficult to find information on each function because there are many contents in the manual.

A digital manual has been used for displaying a vehicle part and a state thereof as a still image and a manipulation method of the vehicle part as a motion picture, but it may not provide a customized manual for the driver.

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to provide a system and a method for providing a digital manual for a vehicle having advantages of providing a customized digital manual to a driver.

An exemplary embodiment according to the present inventive concept may be used to achieve another effort which is not particularly disclosed in addition to the above effort.

A system for providing a digital manual according to an exemplary embodiment of the present inventive concept may include an information collector configured to collect model and option information of a first vehicle currently owned by a driver and a model and option information of a second vehicle previously owned by the driver. A manual generator is configured to generate the digital manual based on the model and option information of the first vehicle and the model and option information of the second vehicle. A manual provider is configured to provide the digital manual to the first vehicle.

The manual generator may generate a supplementary manual for a new function of the first vehicle which is not provided in the second vehicle based on the model and option information of the first vehicle and the model and option information of the second vehicle.

The information collector may collect usage frequency information of respective functions of the first vehicle.

The system may further include a function recommender configured to generate recommendation information regarding a specific function of the first vehicle if the usage frequency of the specific function is less than a reference value set for the specific function.

The information collector may collect FAQ information corresponding to keywords searched by other drivers who have the same vehicle model as the first vehicle.

The manual generator may generate an FAQ manual based on the FAQ information.

The system may further include an input device configured to receive information on the digital manual desired by the driver or a manual search keyword. A manual searcher is configured to search a database for the digital manual based on the information on the digital manual. An output device is configured to display the digital manual.

A method for providing a digital manual by a server according to an exemplary embodiment of the present inventive concept may include collecting model and option information of a first vehicle currently owned by a driver and model and option information of a second vehicle previously owned by the driver. The digital manual is generated based on the model and option information of the first vehicle and the model and option information of the second vehicle. The digital manual is provided to the first vehicle.

The digital manual may include a supplementary manual for a new function of the first vehicle which is not provided in the second vehicle.

The method may further include collecting usage frequency information of respective functions of the first vehicle. Recommendation information regarding a specific function of the first vehicle is generated if the usage frequency of the specific function is less than a reference value of the specific function. The recommendation information is provided to the first vehicle.

The method may further include collecting FAQ information corresponding to keywords searched by other drivers who own a vehicle of the same type as the first vehicle.

The digital manual may include an FAQ manual generated based on FAQ information.

According to an exemplary embodiment of the present inventive concept, the customized digital manual may be provided to the driver based on the personalized data of the driver.

### BRIEF DESCRIPTION OF THE DRAWINGS

FIG. 1 is a block diagram of a system for providing a digital manual according to an exemplary embodiment of the present inventive concept.

FIG. 2 is a flowchart of a method for providing a digital manual according to an exemplary embodiment of the present inventive concept.

FIG. 3 is a flowchart of a method for providing a digital manual desired by a driver according to an exemplary embodiment of the present inventive concept.

### DETAILED DESCRIPTION OF THE EMBODIMENTS

The present disclosure will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive, and like reference numerals designate like elements throughout the specification. Further, a detailed description of the widely known related art will be omitted.

In the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

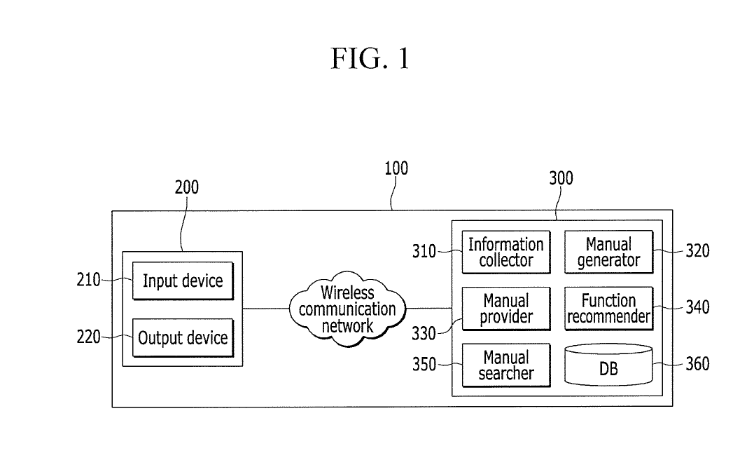

FIG. 1 is a block diagram of a system for providing a digital manual according to an exemplary embodiment of the present inventive concept.

A system 100 for providing a digital manual for a vehicle according to an exemplary embodiment of the present inventive concept includes a device 200 within vehicle and a server 300. The device 200 and the server 300 are connected to each other through a wireless communication network.

The device 200 includes an input device 210 and an output device 220.

The server 300 includes an information collector 310, a manual generator 320, a manual provider 330, a function recommender 340, a manual searcher 350, and a database 360.

The information collector 310 may collect model information, option information, and usage frequency information of respective functions of a first vehicle which is currently owned by a driver.

For example, the information collector 310 may collect “LF Sonata” as the model information of the first vehicle. The information collector 310 may collect a panorama sunroof, a lane keeping assist system, a navigation device, and the like as the option information. The information collector 310 may collect the number of uses of a cruise control function during a preset period as the usage frequency information of the cruise control function.

In addition, the information collector 310 may collect model information and option information of a second vehicle which was previously owned by the driver. For example, the model and option information of the second vehicle may be automatically collected if the driver has subscribed to a telematics service. The telematics service may provide various services, such as route guidance service, vehicle diagnosis service, remote control service, and the like by utilizing the device 200 within the first vehicle. The model and option information of the second vehicle may be directly collected by a driver input.

Further, the information collector 310 may collect frequently asked questions (FAQ) information corresponding to keywords searched by other drivers who own a vehicle of the same type as the first vehicle. For example, the information collector 310 may collect keywords related to functions of the LF Sonata searched by the drivers who own the LF Sonata.

The manual generator 320 generates the digital manual based on the model and option information of the first vehicle, model and option information of the second vehicle, and the FAQ information.

The digital manual may include a supplementary manual and an FAQ (frequently asked questions) manual.

For example, the manual generator 320 may generate the supplementary manual for a method of using a new function of the first vehicle which is not provided in the second vehicle based on the model and option information of the first vehicle and the model and option information of the second vehicle.

The driver may recognize only the method of using new functions of the first vehicle through the supplementary manual, and thus, the time used to recognize the new functions can be saved.

The manual generator 320 may generate the FAQ manual for keywords having a high search frequency based on the FAQ information corresponding to keywords searched by other drivers who own a vehicle of the same type as the first vehicle.

The driver may recognize information on functions frequently searched by other drivers, and thus necessary information for management of the first vehicle can be checked in advance.

The manual provider 330 provides the digital manual generated from the manual generator 320 to the device 200.

The manual provider 330 may provide a digital manual requested by the driver to the device 200 as well as the supplementary manual and the FAQ manual.

The function recommender 340 may generate recommendation information of the first vehicle based on the usage frequency information of respective functions of the first vehicle. The recommendation information is provided to the device 200 within the first vehicle. A reference value may be set for each function of the first vehicle. If a usage frequency of a specific function is less than a reference value set for the specific function, the function recommender 340 may generate recommendation information regarding the specific function. Accordingly, the driver may check the recommendation information to recognize the specific function that could not be used because the driver does not know how to use the specific function.

The database 360 stores information collected by the information collector 310 and the digital manual generated by the manual generator 320.

The input device 210 generates input data for controlling an operation of the device 200 within the vehicle by the driver. The input device 210 may include a touch pad, a key pad, a jog shuttle, and the like. The input device 210 may receive the model and option information of the second vehicle, information on the digital manual desired by the driver, or a manual search keyword.

The driver may input the information on the desired digital manual and check the desired digital manual.

The manual search keyword is a keyword for searching necessary contents from among contents of the digital manual. The driver may input the manual search keyword through the input device 210 to search for the necessary contents of the digital manual.

The manual searcher 350 searches for the digital manual based on the information on the digital manual desired by the driver. The manual searcher 350 may search the database 360 for the digital manual desired by the driver.

The output device 220 may display the digital manual. The output device 220 may display the digital manual provided from the manual provider 330 and the recommendation information of the first vehicle generated from the function recommender 340.

The system 100 may provide a customized digital manual to the driver based on the personalized data of the driver. Accordingly, the driver may conveniently and efficiently use the digital manual, thereby easily and quickly recognizing functions of the first vehicle.

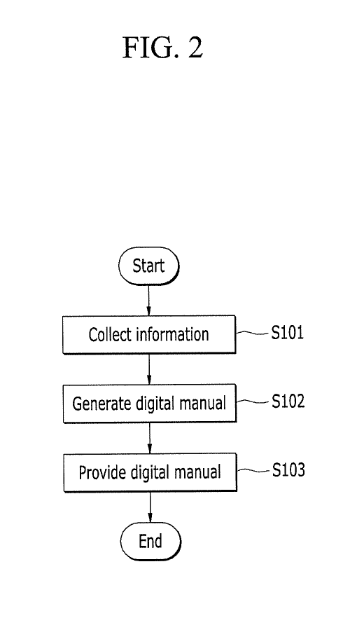

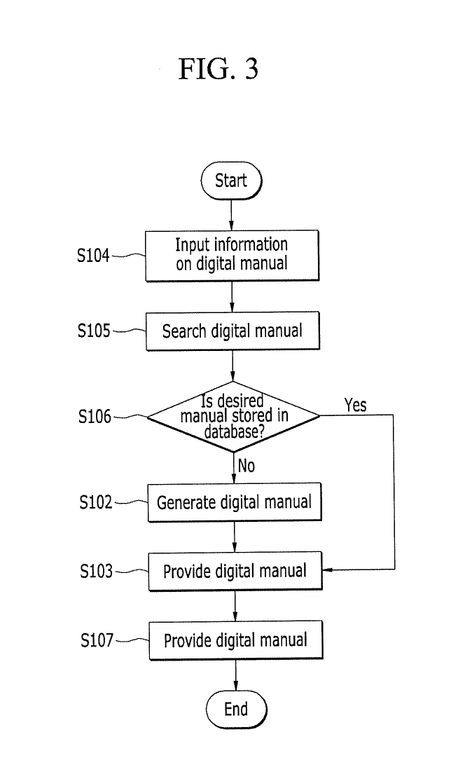

Hereinafter, referring FIGS. 2 and 3, a method for providing a digital manual according to an exemplary embodiment of the present inventive concept will be described in detail. Explanations that have already been made with reference to the system 100 will be omitted.

FIG. 2 is a flowchart of a method for providing a digital manual according to an exemplary embodiment of the present inventive concept.

As shown in FIG. 2, the server 300 may collect the model and option information and the usage frequency information of respective functions of the first vehicle currently owned by the driver, the model and option information of the second vehicle, and the FAQ information corresponding to keywords searched by other drivers who own a vehicle of the same type as the first vehicle at step S101.

The server 300 may generate the digital manual based on the model and option information and the usage frequency information of the respective functions of the first vehicle, the model and option information of the second vehicle, and the FAQ information at step S102.

The server 300 may generate the supplementary manual for a method of using a new function of the first vehicle which is not provided in the second vehicle based on the model and option information of the first vehicle, and the model and option information of the second vehicle.

In addition, the server 300 may generate the FAQ manual for keywords having a high search frequency based on the FAQ information. The server 300 may provide the generated digital manual to the device 200 within the first vehicle at step S103.

FIG. 3 is a flowchart of a method for providing a digital manual desired by a driver according to an exemplary embodiment of the present inventive concept.

As shown in FIG. 3, the driver inputs information on the desired digital manual through the input device 210 at step S104. In addition, the driver may input the model and option information of the second vehicle, the manual search keyword, and the like.

The server 300 searches for the digital manual based on the information on the digital manual desired by the driver at step S105.

If the digital manual related to the information on the desired manual is stored in the database 360 at step S106, the server 300 provides the digital manual to the device 200 at step S103, and the device 200 displays the digital manual at step S107.

If the digital manual related to the information on the desired manual is not stored in the database 360 at step S106, the server 300 generates the digital manual related to the information on the desired manual at step S102.

After that, the server 300 provides the generated digital manual to the device 200 within the vehicle at step S103, and the device 200 displays the digital manual at step S107.

According to an exemplary embodiment of the present inventive concept, the customized digital manual may be provided to the driver based on the personalized data of the driver. In addition, the driver may conveniently and efficiently use the digital manual, thereby easily and quickly recognizing functions of the first vehicle.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for providing a digital manual, comprising:
an information collector configured to collect model and option information of a first vehicle currently owned by a driver and model and option information of a second vehicle previously owned by the driver;
a manual generator configured to generate the digital manual based on the model and option information of the first vehicle and the model and option information of the second vehicle; and
a manual provider configured to provide the digital manual to the first vehicle.

2. The system of claim 1, wherein the manual generator generates a supplementary manual for a new function of the first vehicle which is not provided in the second vehicle based on the model and option information of the first vehicle, and the model and option information of the second vehicle.

3. The system of claim 1, wherein the information collector collects usage frequency information of respective functions of the first vehicle.

4. The system of claim 3, further comprising a function recommender configured to generate recommendation information regarding a specific function of the first vehicle if the usage frequency of the specific function is less than a reference value of the specific function.

5. The system of claim 1, wherein the information collector collects frequently asked questions (FAQ) information corresponding to keywords searched by other drivers who have the same vehicle model as the first vehicle.

6. The system of claim 5, wherein the manual generator generates an FAQ manual based on the FAQ information.

7. The system of claim 1, further comprising:
an input device configured to receive information on the digital manual desired by the driver or a manual search keyword;
a manual searcher configured to search a database for the digital manual based on the information on the digital manual; and
an output device configured to display the digital manual.

8. A method for providing a digital manual by a server, comprising:
collecting, by an information collector, model and option information of a first vehicle currently owned by a driver and model and option information of a second vehicle previously owned by the driver;
generating, by a manual generator, the digital manual based on the model and option information of the first vehicle and the model and option information of the second vehicle; and
providing the digital manual to the first vehicle.

9. The method of claim 8, wherein the digital manual comprises a supplementary manual for a new function of the first vehicle which is not provided in the second vehicle.

10. The method of claim 8, further comprising:
collecting usage frequency information of respective functions of the first vehicle;
generating recommendation information regarding a specific function of the first vehicle if the usage frequency of the specific function is less than a reference value of the specific function; and
providing the recommendation information to the first vehicle.

11. The method of claim 8, further comprising collecting FAQ information corresponding to keywords searched by other drivers who have the same vehicle model as the first vehicle.

12. The method of claim 8, wherein the digital manual comprises an FAQ manual generated based on FAQ information.
